(19) United States
(12) Patent Application Publication
(10) Pub. No.: US 2019/0229454 A1
(43) Pub. Date: Jul. 25, 2019

(54) ELECTRICAL CABLE WITH ELECTRONIC TAG

(71) Applicant: Marmon Retail Electrical Products, Inc., Niles, IL (US)

(72) Inventors: Salvador Contreras, Niles, IL (US); Shiao-Tsun Ku, Fishers, IN (US)

(21) Appl. No.: 16/031,652

(22) Filed: Jul. 10, 2018

Related U.S. Application Data
(60) Provisional application No. 62/619,502, filed on Jan. 19, 2018.

(51) Int. Cl. H01R 13/46; G06K 7/10; H01B 9/00

(52) U.S. Cl. CPC H01R 13/465; H01B 9/006; G06K 7/10386

(57) ABSTRACT

An electrical cable for transmitting power is disclosed having a cable portion, a plug, a receptacle, and an electronic tag, where the electronic tag may communicate with a portable electronic device. A user may enter data such as his name or other information such that when the user uses the portable electronic device to communicate with the electronic tag, the user may easily identify his or her extension cord. The electronic tag may also communicate location information allowing the user to track the location of the electrical cable from a remote location.

### CROSS-REFERENCE TO RELATED APPLICATIONS

This application claims priority to U.S. Provisional Application No. 62/619,502 filed on Jan. 19, 2018. The above referenced application is incorporated by reference in its entirety.

### FIELD OF INVENTION

This disclosure relates to an electrical cable for transmitting power with an electronic identification device.

### BACKGROUND

Extension cords and electrical cables are often used at construction sites and other jobs. While working at these construction sites, each worker may be required to bring his own extension cord or cords with him to power his tools and equipment. As many extension cords may look alike, there may be confusion in identifying and tracking the cords brought to the job site. A simple and effective system to identify and track extension cords would be helpful.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of this disclosure may relate to a system for identifying an electrical cable comprising an electronic tag configured to communicate wirelessly with a portable electronic device, where the portable electronic device provides a user interface to allow a user to enter information into the portable electronic device and where the entered information is stored, and a sleeve attached to an electrical cable configured to transmit electrical power such that the sleeve houses the electronic tag. The electronic tag may comprise a near field communication type tag, while in other embodiments the electronic tag may comprise a radio frequency identification type tag. The electrical cable may be an extension cord comprising a plug at one end, a receptacle at the opposite end, and a cable portion extending between the plug and the receptacle, where the sleeve is wrapped around the cable portion of the extension cord. The sleeve may comprise a top cover and a bottom plate that when secured together wrap around the electrical cable. The top cover and the bottom plate of the sleeve may be secured together with a snap fit connection. In addition, the electronic tag may be secured within the sleeve between the bottom plate and the cable portion. The sleeve may further include a groove that engages a rib on the receptacle.

Other aspects of this disclosure may relate to a system where the portable electronic device comprises a processor and a non-transitory computer readable medium storing computer readable instructions that, when executed by the processor causes the processor to at least: read data stored on the electronic tag when the portable electronic device is placed near the electronic tag; determine if the electrical cable is registered; and upon determining that the electrical cable has not been registered, prompt a user using a display of the portable electronic device to enter information.

Still other aspects of this disclosure may relate to a system for identifying an extension cord comprising an electronic tag configured to communicate wirelessly with a portable electronic device, where the portable electronic device provides a user interface to allow a user to enter information into the portable electronic device, where the user entered information is stored; an extension cord comprising a plug portion at a first end, a receptacle portion at a second end, and a cable portion extending between the plug portion and the receptacle portion, where the extension cord is configured to transmit power from a power source to a powered device; and a sleeve securing the electronic tag to the extension cord, where the sleeve wraps around the extension cord. The electronic tag may be a near field communication type tag. The sleeve may comprise a top cover and a bottom plate that are secured together with a snap fit connection. The sleeve may also be adjacent to an end of the receptacle portion or may be adjacent to an end of the plug portion. The sleeve may have a maximum width that is equal to or less than a maximum width of the receptacle portion. The system may further include a portable electronic device that comprises a processor and a non-transitory computer readable medium storing computer readable instructions that, when executed by the processor causes the processor to at least: read data stored on the electronic tag when the portable electronic device is placed near the electronic tag; determine if the extension cord is registered; and upon determining that the extension cord has not been registered, prompt a user using a display of the portable electronic device to enter information.

Yet even further aspects of this disclosure may relate to the portable electronic device comprising a processor and a non-transitory computer readable medium storing computer readable instructions that, when executed by the processor causes the processor to at least: read data stored on the electronic tag when the portable electronic device is placed near the electronic tag; determine if the extension cord is registered; and upon determining that the extension cord has been registered, display information related to the user. In addition, the electronic tag may communicate location information such that a location of the extension cord may be tracked from a remote location, where the electronic tag may communicate with a global positioning system satellite to determine the location information.

Still another aspect of this disclosure may relate to a system for identifying an extension cord comprising an electronic tag configured to communicate wirelessly with a portable electronic device, where the portable electronic device provides a user interface to allow a user to enter information into the portable electronic device, where the user entered information is stored, and an extension cord that includes a plug portion at a first end, a receptacle portion at a second end, and a cable portion extending between the plug portion and the receptacle portion, where the extension cord is configured to transmit power from a power source to a powered device, and a label formed from a flexible material securing the electronic tag to the extension cord, where the label wraps around the extension cord.

### BRIEF DESCRIPTION OF DRAWINGS

To allow for a more full understanding of the present disclosure, it will now be described by way of example, with reference to the accompanying drawings in which:

FIG. 1 depicts an example system for identifying an electrical cable as disclosed herein;

FIG. 2A depicts a view of an exterior side of an exemplary label that includes an electronic tag as disclosed herein; and

FIG. 2B depicts a view of an interior side of an exemplary label that includes an electronic tag as disclosed herein;

FIG. 2C depicts a view of an exemplary folded label around a that includes an electronic tag as disclosed herein;

FIG. 3 depicts an illustrative flowchart diagram to identify and locate a cable as disclosed herein;

FIG. 4 depicts a view of an alternate embodiment of an electrical cable as disclosed herein;

FIGS. 5A-5C depict a view of alternate embodiments of the location of the electronic tag on the cable as disclosed herein;

FIG. 6A depicts a view of alternate embodiment of the electronic tag on the cable as disclosed herein;

FIG. 6B depicts an exploded perspective view of the embodiment of the electronic tag on the cable of FIG. 6A as disclosed herein;

FIG. 6C depicts an exploded perspective view of the embodiment of the electronic tag on the cable of FIG. 6A as disclosed herein;

FIG. 6D depicts a top view of the embodiment of the electronic tag on the cable of FIG. 6A as disclosed herein;

FIGS. 7A-7C depict cross-sectional views of the assembly of an electronic tag holder of FIGS. 6A-6D with some components removed for clarity as disclosed herein;

FIGS. 8A-8B depict perspective views of the electronic tag holder of FIGS. 6A-6D with the cable removed for clarity according to aspects disclosed herein;

FIG. 9A depicts a schematic of an identification and tracking method of an electrical cable with the electronic tag according to aspects disclosed herein; and

FIG. 9B depicts a schematic of an identification and tracking method of an electrical cable with the electronic tag according to aspects disclosed herein.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Nothing in this specification should be construed as requiring a specific three-dimensional orientation of structures in order to fall within the scope of this invention, unless explicitly specified by the claims. Further, “providing” an article, as used herein, refers broadly to making an article available or accessible for future actions to be performed on the article, and does not connote that the party providing the article has manufactured, produced, or supplied the article or that the party providing the article has ownership or control of the article. The reader is also advised that the attached drawings are not necessarily drawn to scale.

In general, this disclosure relates to a system 100 using an electronic tag 124 to identify and track an electrical cable 110, such as an extension cord or multiple extension cords.

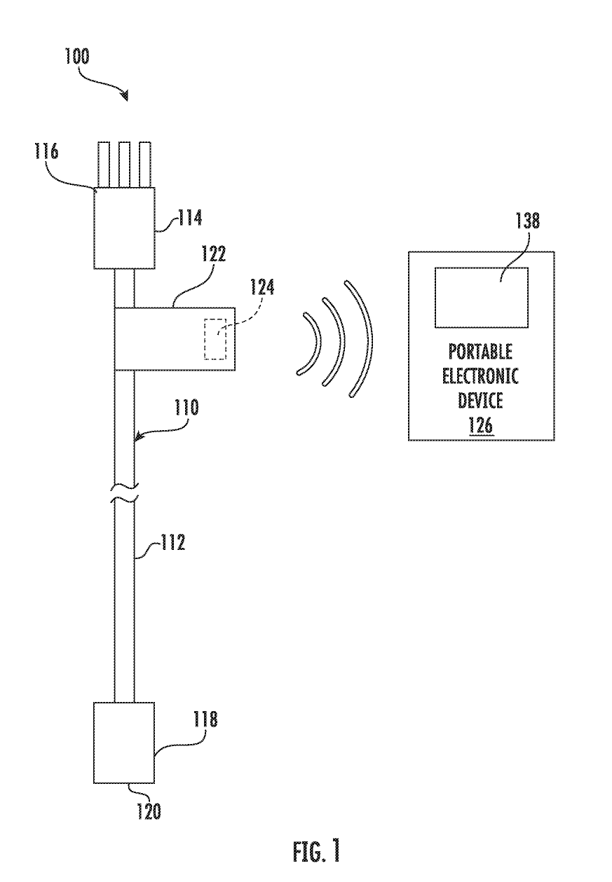

FIG. 1 discloses an embodiment of the system 100 for tracking and/or identifying an extension cord 110 or power cord. The system 100 may comprise a portable electronic device 126 that can communicate with an electronic tag 124 that is connected to an extension cord 110. The extension cord 110 may comprise a cable portion 112 having a plug portion 114 at first end 116 and a receptacle portion 118 positioned at a second end 120 opposite the first end 116. The extension cord 110 may be used to transmit power from a power source to a powered device as known to one skilled in the art. The extension cord 110 may further comprise a label 122, where the label 122 may have an electronic tag 124 attached.

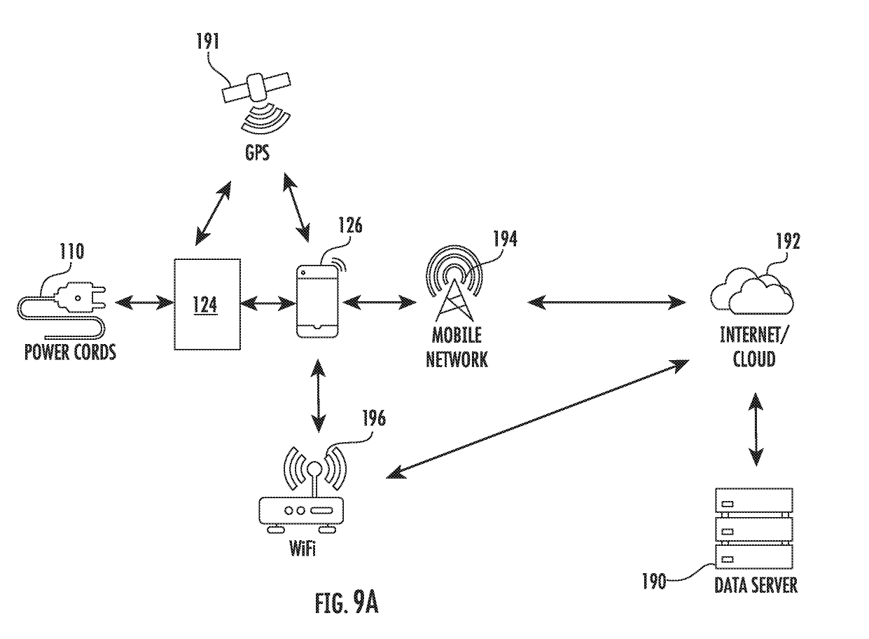

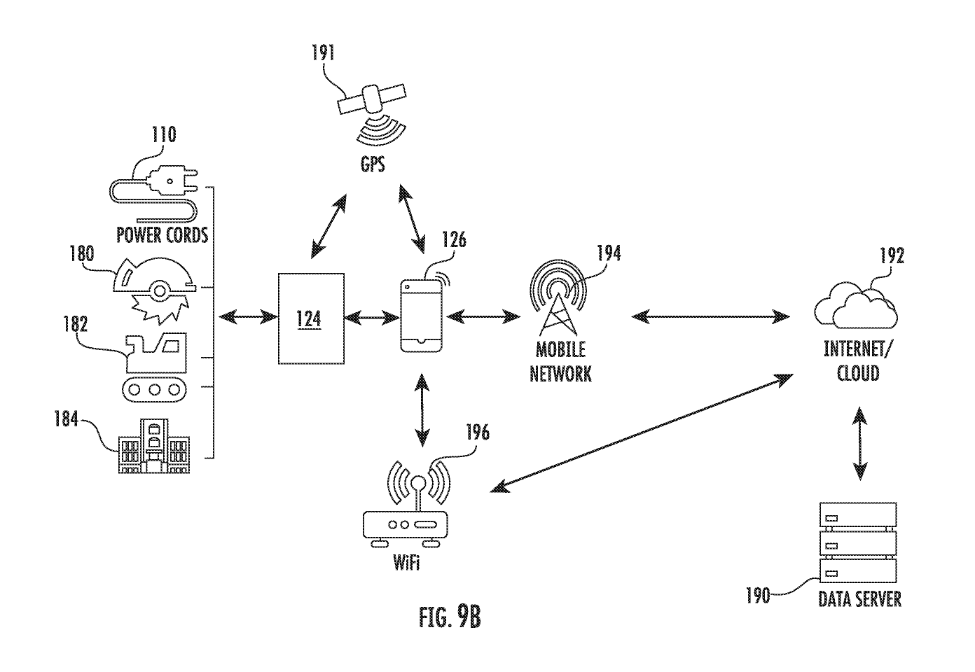

The portable electronic device 126 may be equipped to transmit and receive a signal from the electronic tag 124. The portable electronic device 126 may communicate with the electronic tag 124 such that a user of the extension cord 110 may be able to enter data to the electronic tag 124. Further, the portable electronic device 126 may include a display 138. The display 138 may visually communicate the information received from the electronic tag 124 to the user. For example, the entered data from the user may include the user's name, his or her contact information such as a phone number or address, the location the extension cord was purchased, or other information that may help the user to identify a particular extension cord 110. The electronic tag 124 may then retain the entered data and can communicate the entered data back to the portable electronic device 126 when requested. As another option, the portable electronic device 126 may communicate with a remote data server 190 to store the user entered information and associate it with a unique identifier or code associated with a particular electronic tag 124 as discussed below and shown in FIGS. 9A and 9B. During the communication between the portable electronic device 126 and the electronic tag 124, the portable electronic device 126 may display the entered data stored on the electronic tag 124, such as the user's name and/or contact information. Additionally, or optionally, the portable electronic device 126 may read the data on the electronic tag 124 such as a unique identifier or code and communicate with the remote data server 190, and then display the user entered information or stored on the data server 190 associated with the unique code of the particular electronic tag 124. Subsequently, the user may then distinguish his or her extension cord 110 from an identical looking extension cord that may be registered to another owner or may not have an electronic tag 124.

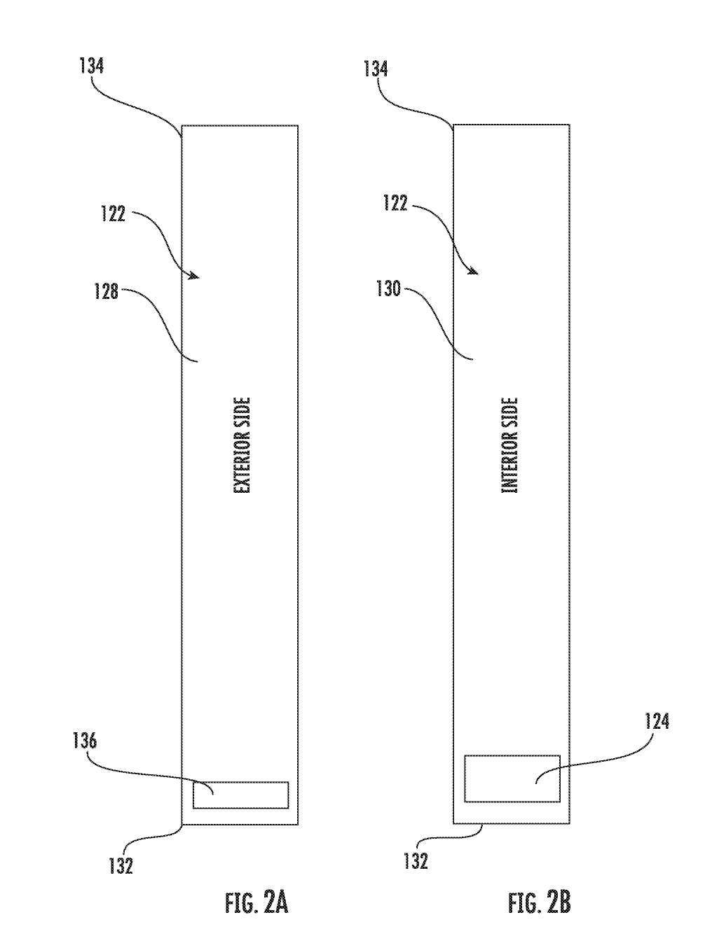

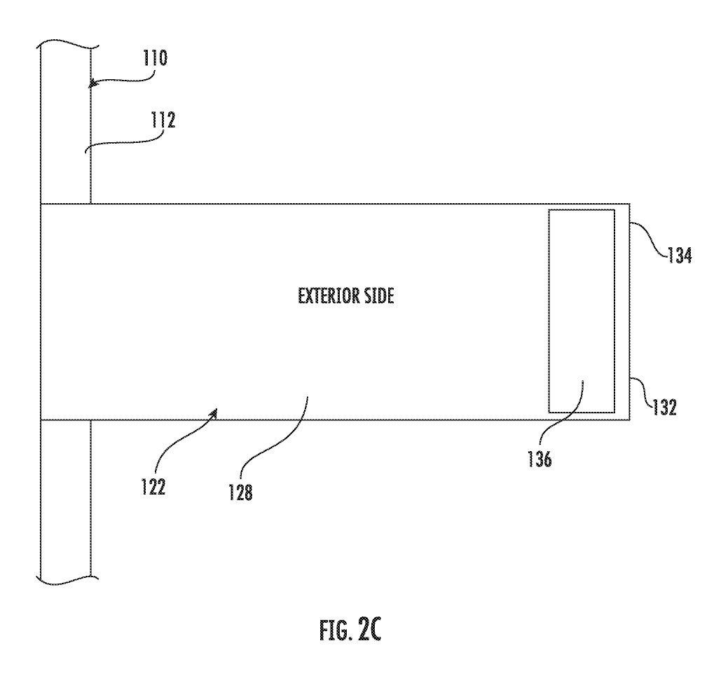

FIGS. 2A-2C illustrate an exemplary label 122. The label 122 may be a label made of a flexible material with an exterior or front side 128 and an interior or back side 130. The front side 128 may have printed information that may include safety information, product information, branding information, or other information, as shown in FIG. 2A. The interior or back side 130 may include a portion having an adhesive, as shown in FIG. 2B. For example, the label 122 may have information required by the Underwriter's Laboratory (UL) or Universal Product Code (UPC) information. The label 122 may be substantially rectangular in shape with a first end 132 and a second end 134 opposite the first end 132. Alternatively, the label 122 may be square or any shape. The label 122 may be wrapped around the cable portion 112 where a portion of the interior side 130 of the label 122 contacts the exterior surface of the cable portion 112 and the interior side 130 near the first end 132 contacts the interior side near the second end 134. A portion of the label 122 may extend away from the cable portion 112 where the ends 132, 134 of the label 122 are located beyond a width of the plug 114. When the label 122 is wrapped around the extension cord 110, the first end 132 may be substantially aligned with the second end 134. The adhesive on the interior side 130 of the label may secure the first end 132 to the second end 134 and may secure the label 122 to the cable 112. FIG. 2C illustrates a label 122 that is folded around the extension cord 110 with the first end 132 substantially aligned with the second end 134.

The electronic tag 124 may be secured to the label 122. For example, as shown in FIG. 2B the electronic tag 124 may be located on and attached to the interior side 130 of the label 122, such that it is secured to the extension cord 110 when the label 122 is wrapped around the extension cord 110. The exterior side 128 may have a registration label 136 that communicates the location of the electronic tag 124 on the label 122 so the user may know where to position the portable electronic device 126 to effectively scan the electronic tag 124. The registration label 136 may have a size similar such that the length of the registration label 136 is substantially the same as the length of the electronic tag 124. The registration label 136 may be a label or sticker placed onto the exterior side 128 of the label 122 in the region of the label 122 over where the electronic tag 124 is secured on the label 122. In addition, the registration label 136 may have additional information to assist a user with communicating with the electronic tag 124 such as the corresponding serial number of the electronic tag 124, initial login and initial password information, or information communicating how to obtain the proper software application to allow the portable electronic device 126 to communicate with the electronic tag 124.

As another option, the electronic tag 124 may attached to a label formed of a polymer that is attached to the cable portion 112 of the extension cord 110 with a cable tie, such as a zip tie or similar component. As still another option, the electronic tag 124 may be attached to a sleeve that fits around the cable portion 112 of the extension cord 110. The sleeve may be placed on the cable 112 of the extension cord 110 before attaching either the plug 114 or the receptacle 118 to the cable 112, where the plug 114 and the receptacle 118 prevent the sleeve from being removed from the extension cord 110.

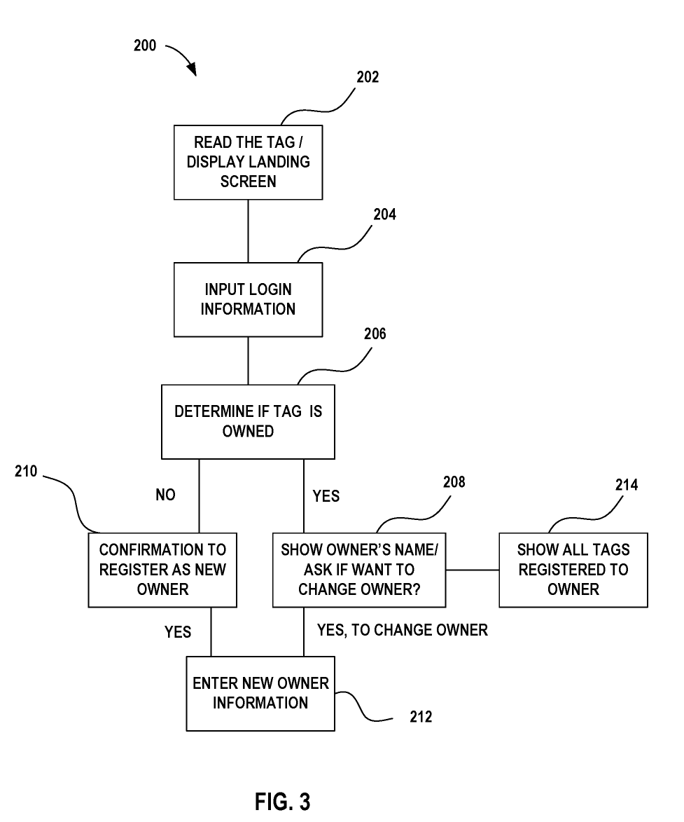

FIG. 3 shows an exemplary process 200 the portable electronic device 126 may use to allow the user to enter and receive data from the electronic tag 124. The user may download a software application that includes the process 200 to the portable electronic device 126 that may be executed by the processor of the portable electronic device 126. Initially, the portable electronic device 126 may display a “Landing Screen” or intro screen for the system. The user may place the device 126 near the electronic tag 124 so the device 126 may read the data from the electronic tag 124. For example, the portable electronic device 126 may be held within 6 inches of electronic tag 124 to read or scan the electronic tag 124. Once the data on the tag 124 is read, the portable electronic device 126 may then display the data read from the tag 124 on the display 138 of the portable electronic device 126 (202). The process may further include a login screen for the user to enter a username and password, a serial number, or other registration information found on the registration label 136 into the application as a security measure (204). Next, the portable electronic device 126 may synchronize the portable electronic device 126 to the electronic tag 124 and determine from the data obtained from the electronic tag 124 if the extension cord 110, or tag 124, has previously been registered (206). The synchronization process may include the portable electronic device acquiring locally stored data on the tag 124, acquiring locally stored data on the portable electronic device 126, or the portable electronic device 126 may communicate wirelessly with a remote data server 190 to acquire the stored data to properly complete the synchronization process and determine if the extension cord 110 or tag 124 has previously been registered. If the extension cord 110, or tag 124, has already been registered, the portable electronic device 126 may display the stored user information associated with that particular tag 124 or username, such as the name of the owner of the extension cord 110, or tag 124 (208). The portable electronic device 126 may also display an option for the user to change the owner of the extension cord 110, or tag 124, or update the owner's information (208). If the extension cord 110 has not been previously registered, the portable electronic device 126 may prompt the user if they wish to register as the owner of the extension cord 110 (210). If the user wishes to register as the owner of the extension cord 110 (or tag 124), the user may be prompted on the display 138 to enter his or her name along with other information, such as an email address or phone number (212). In addition, once the user is logged in, the portable electronic device 126 may also display any and all extension cords 110 (or tags 124) that are registered to the user or username (214) by communicating with the remote data server 190. After the user has registered as the owner, when the electronic tag 124 is read by a portable electronic device 126, the display 138 on the portable electronic device 126 will display the owner's information to the user of the portable electronic device 126. As such, an owner may easily identify and distinguish his or her particular extension cord 110. Alternatively, the data stored on the electronic tag 124 may include a unique identifier or code associated with a particular electronic tag 124 and may also include a serial number of the extension cord 110.

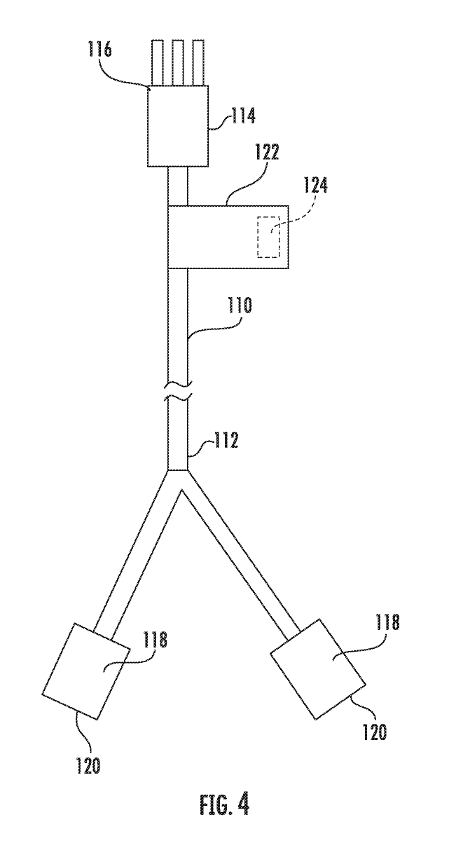

As discussed above, the extension cord 110 may generally have a single receptacle and a single plug, however, the extension cord 110 may have alternate embodiments having a plurality of receptacles as shown in FIG. 4. The number of receptacles may comprise two receptacles as shown, but may have three receptacles, four receptacles, or even six receptacles. In short, the number of receptacles may be any reasonable number of receptacles that can be supported by the electrical current carrying capacity of the cable portion 112.

The electronic tag 124 may comprise a radio frequency identification (RFID) type tag, a near field communication (NFC) type tag, or any similar device that can communicate wirelessly with another electronic device. The electronic tag 124 may have read/write capability where each electronic tag 124 may allow the user to enter data or information that can be stored on the electronic tag 124. In addition, the electronic tag 124 may be a passive device, such that it is not directly connected to a power source. The electronic tag 124 may be powered by the interaction between the portable electronic device 126 and the electronic tag 124, when the portable electronic device 126 is positioned near the electronic tag 124 and sends the tag 124 an appropriate signal. Alternatively, the electronic tag 124 may be an active device that is connected to a power source.

The electronic tag 124 may further be a relatively flat device with a minimal height and a generally rectangular shape. Alternatively, the electronic tag 124 may have a different shape such as a square shape or any geometric shape. In addition, electronic tag 124 may have a length of approximately 29 mm long, or within a range of 17 mm to 41 mm, or within a range of 25 mm and 33 mm. In addition, the electronic tag 124 may have a width of approximately 14 mm, or within a range of 8 mm to 20 mm wide, or 10 mm to 18 mm.

The portable electronic device 126 may be any portable electronic device capable of communicating with an electronic tag 124, such as a cellular phone, an RFID reader, or other similar device. The portable electronic device 126 may further comprise a display 138 used to communicate the information received from the electronic tag 124 to the user. The portable electronic device 126 may include a processor that is capable of implementing any of the various aspects and features described herein related to the software application, the process steps, or implementations described throughout this disclosure that may utilize logical blocks, modules, and circuits.

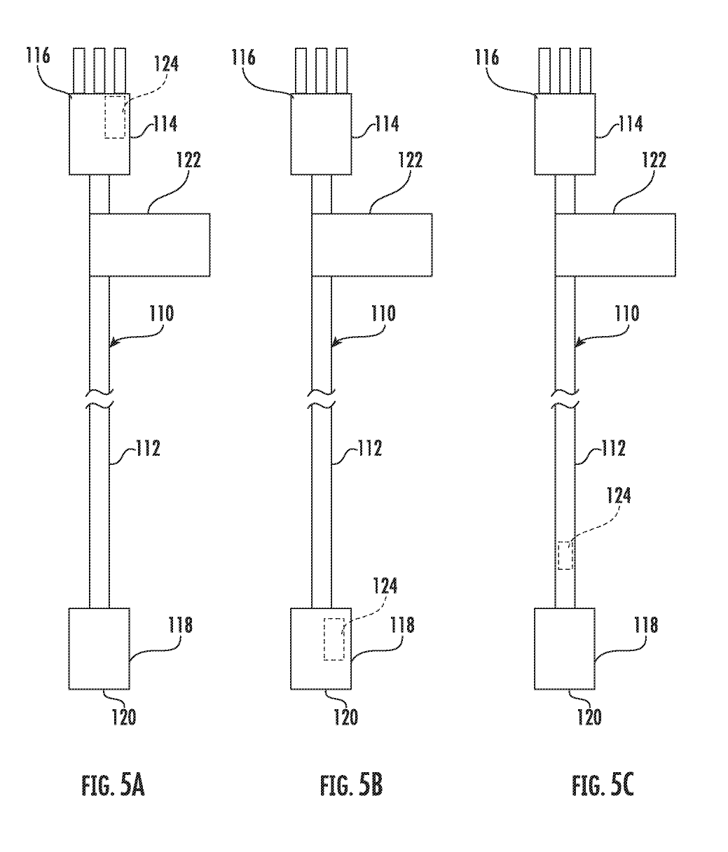

As other options, the electronic tag 124 may be placed anywhere on the extension cord 110, such as the plug 114 shown in FIG. 5A, the receptacle 118 shown in FIG. 5B, or even on the cable portion 112 as shown in FIG. 5C. As another option, the extension cord 110 may have a cover that fits over the end of the receptacle 118 or the plug 114. The cover may have the electronic tag 124 attached or embedded into it.

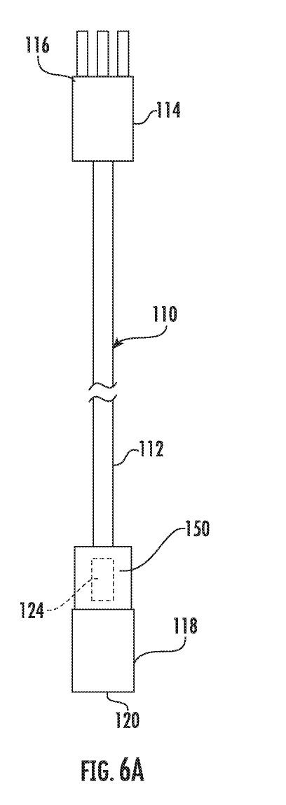

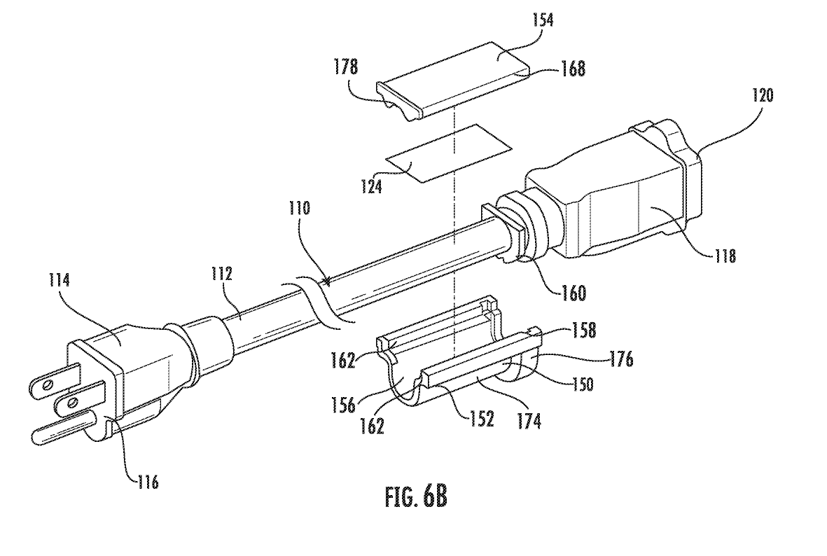

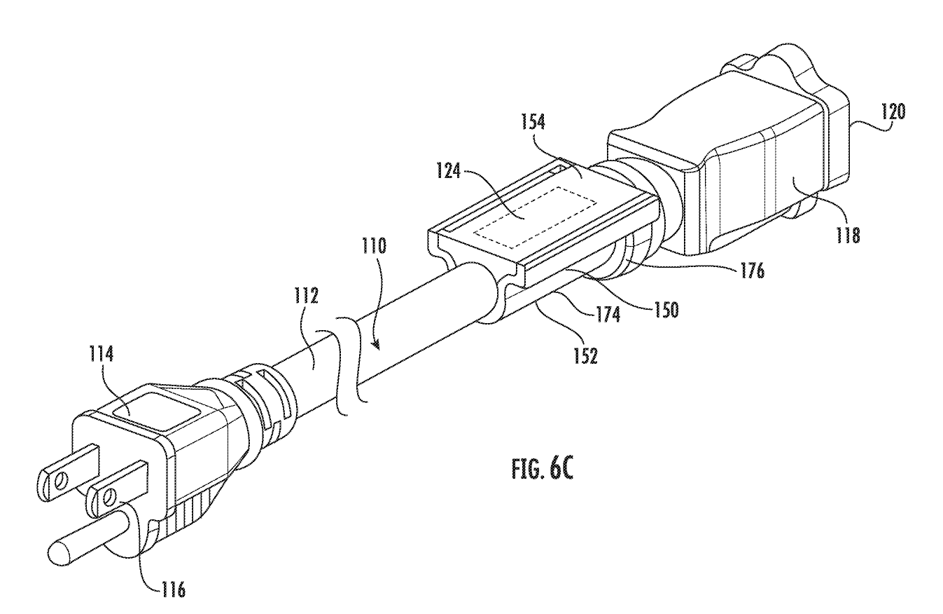

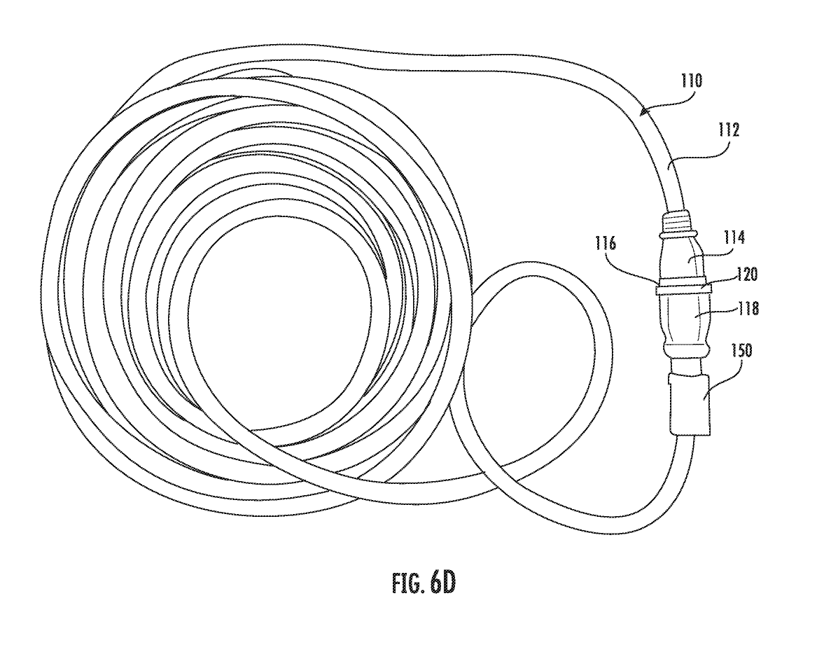

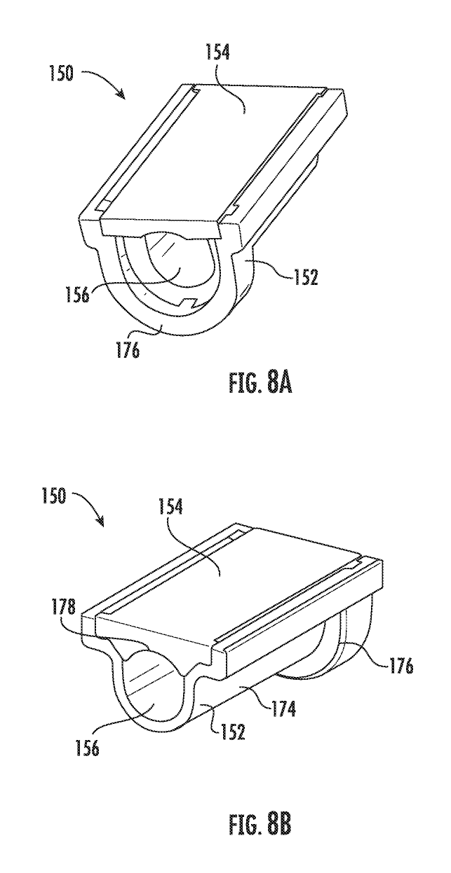

FIGS. 6A-8B illustrate another embodiment for attaching the electronic tag 124 to the electrical cable 110. The components of the electrical cable 110 may be similar as described above and are labeled the same. Thus, these electrical cable components are described in lesser detail or no detail at all. As discussed above, the electronic tag 124 may be attached to the electrical cable 110 using a sleeve 150 that wraps around the cable portion 112. As shown in FIGS. 6A-6C, the sleeve 150 may be attached proximate and may even be contacting the receptacle 118 of the electrical cable 110. Alternatively, the sleeve 150 may be positioned proximate or contacting the plug portion 114, or as another option, the sleeve 150 may be located anywhere along the cable portion 112.

As shown in FIG. 6B, the sleeve 150 may be assembled around the cable portion 112 and comprise a top cover 152 and a bottom plate 154. The electronic tag 124 may be placed onto the bottom plate 154 and then secured within the sleeve 150 between the bottom plate and the cable portion 112 of the electrical cable 110 when the bottom plate 154 is secured to the top cover 152. The electronic tag 124 may also have an adhesive attached to at least one side to secure the tag 124 to the bottom plate 154 during the assembly process and also during operation. The top cover 152 may have an opening 156 extending the length of the sleeve 150 to allow the cable portion 112 of the electrical cable 110 to be positioned within the opening 156. Once the cable portion 112 is positioned within the opening 156, the bottom plate 154 may be secured to the top cover 152, which secures the electronic tag 124 within the sleeve 150 and to the cable portion 112. In addition, the sleeve 150 may comprise an engaging feature or groove 158 that secures a rib 160 that is located on the receptacle 118. The rib 160 may extend into the groove 158 of the sleeve 150 to fix the location of the sleeve 150 adjacent to an end of the receptacle 118. As an alternate embodiment, the rib 160 may be on the plug 114 of the electrical cable 110 such that the sleeve may be located adjacent to an end of the plug 114.

The bottom plate 154 may be secured to the top cover 152 using a mechanical connection, such as using mechanical fasteners, or a snap fit connection to allow for easy assembly. In addition, the bottom plate 154 may be permanently attached to the top cover 152 to form a substantially integrally joined sleeve 150, such that removing the bottom plate 154 from the top cover 152 may permanently damage the sleeve 150 rendering it unusable. Integrally joining components of the sleeve 150 may discourage any attempt to tamper, remove, or modify the sleeve 150, which may also thwart any attempted theft or misuse of the system 100. For example, once the sleeve 150 is secured to the cable portion 112 of the extension cord 110, the cable portion 112 would need to be cut in order to remove the sleeve 150 from the extension cord 110. As another option, the bottom plate 154 and top cover 152 may be joined using an adhesive or a welding operation such as radio frequency welding to permanently fix the bottom plate 154 to the top cover 152. Alternatively in some embodiments, the bottom plate 154 and top cover 152 may be removably attached. In addition, the sleeve 150 may include a seal between the top cover 152 and the bottom plate 154 to better protect the electronic tag 124 from any environmental contamination such as moisture or dust.

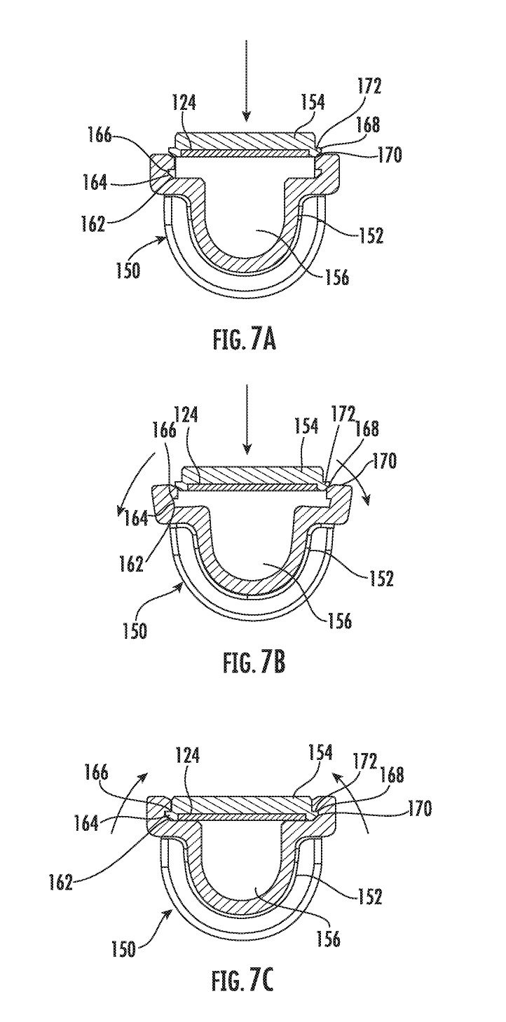

As shown in the exemplary embodiment of FIGS. 6A-8B, the sleeve 150 may be assembled using a snap fit connection where the top cover 152 may have a pair of engaging members 162 located along the edges of the opening 156 that along a majority of the length of the top cover 152. Each engaging member 162 may comprise a groove with an angled surface 164 and a retaining surface 166. The bottom plate 154 may comprise corresponding engaging members 168, having an angled surface 170 and a retaining surface 172. Thus, as shown in FIGS. 7A-7C, as the bottom plate 154 is pressed downward onto the top cover 152, the angled surface 170 contacts the edges of the opening 156 on the top cover 152 causing the opening 156 to expand slightly allowing the engaging members 168 of the bottom plate to move into the engaging members 162 securing the sleeve 150 along with the electronic tag 124 to the electrical cable 110.

In addition, the sleeve 150 may have a shape that minimizes the size and any added weight to the electrical cable 110. For instance, the maximum width of the sleeve 150 may be less than or equal to a maximum width of the receptacle 118. In addition, the top cover 152 may also comprise a generally rounded exterior shape 174 that is generally coaxial with the cable portion 112. A rounded rib 176 may also be located near the end of the cover 152 that is adjacent the receptacle 118 or alternatively adjacent to the plug 114. The bottom plate 154 may have a rounded guide surface 178 to engage the cable portion 112 at the end of the sleeve 150 positioned opposite the receptacle 118 or plug 114. By minimizing the size and profile of the sleeve, the chances for damaging the sleeve 150 and electronic tag 124 may be reduced.

The components of the sleeve 150 may be formed of a polymer material to avoid causing any interference with the electronic signals while also being inert to any chemicals or substances it may contact at the harsh environment of a jobsite. For example, the top cover 152 and the bottom plate 154 may be formed from acrylonitrile butadiene styrene (ABS), polyvinyl chloride (PVC), polycarbonate, or other similar polymer.

FIGS. 9A and 9B disclose additional options for the system 100 as disclosed. As discussed above, in some embodiments, the electronic tag 124 may comprise an active device that includes a power source. For example, the electronic tag 124 may comprise the ability to communicate with global positioning system (GPS) satellites 191 to be able to determine the location of the electronic tag 124, and thus the location of its associated electrical cable 110. For example, the electronic tag 124 may communicate its coordinates associated with its location based upon the communication with the GPS satellites 191. As another option, the portable electronic device 126 may communicate with the GPS satellites 191 as well and may be able to determine the location of the electronic tag 124. In addition, the electronic tag 124 may comprise the ability to communicate to the portable electronic device 126 using a wireless local area network (Wi-Fi), Bluetooth, ZigBee, or other similar wireless means. By using an active device, the distance that the electronic tag 124 may be able to communicate with the portable electronic device 126 increases compared to the distance the electronic tag 124 can communicate when configured as a passive device.

Another option of tracking the electrical cable 110 is to use a code on the label 122. The label 122 may have a bar code, QR code, or similar marking that can be read using the portable electronic device 126 or manually entered into the portable electronic device 126. This bar code or QR code can be used by the portable electronic device 126 to identify a specific electrical cable 110. The portable electronic device 126 may also include the ability to communicate with GPS satellites 191. Thus, the portable electronic device 126 may store the location of the portable electronic device 126 when the label 122 is scanned, and then communicate the location information of the electrical cable 110.

Once the portable electronic device 126 has communicated with the electronic tag 124 or scanned the label 122, the portable electronic device 126 may further communicate to a data server 190 via the internet 192 using a variety of means such as a mobile network 194, Wi-Fi network 196, or similar method. The data server 190 may then store the information communicated by the electronic device 126. This data may include but not limited to the user information as discussed above, the electrical cable's brand and model information, the date and time of the electronic tag's communication with the electronic device 126, the information regarding the electrical cable's location. The data server 190 may also store all of the known communications of the particular electronic tag 124 such that a history of the tag's location and associated user information may be easily available. The data server 190 may then communicate this information back to a user using the display 138 of the portable electronic device 126 such that a user may access this information to track the location of the tag 124 and its associated equipment from a remote location. For example, the portable electronic device 126 may display the location of the tag 124 visually by illustrating the location of the tag 124 on a map on the display 138 or display the locations as a listing of their coordinates and associated addresses. In addition, a user may use the portable electronic device 126 to communicate with the data server 190 at any time to better track any of his/her equipment. The data server 190 may comprise a computer database that is configured to store and analyze data received from communication with the portable electronic device 126, the electronic tag 124, other information related to the electrical cables 110, or other applicable information. The data server 190 may also be configured to communicate with the portable electronic device 126 or electronic tag 124 through various means such as being connected to the internet 192.

As another option shown in FIG. 9B, the electronic tag 124 may be connected to a power cord of various electrical equipment using a similar method as described above. For example, the electronic tag 124 may be connected to the electrical cable or power cord portion of a power tool 180. For example, a power tool 180 may include but not limited to power saws, drills, battery chargers for electrically powered devices, sanders, grinders, blowers or similar devices known to one skilled in the art. In this example, the sleeve 150 comprising the electronic tag 124 may be attached to the cable portion of an electrically powered power tool 180 similarly to its attachment to the extension cord 110 as described above.

Still other embodiments may allow the electronic tag 124 to be mounted on other devices such as construction equipment 182 or other powered devices 184 used in schools or businesses to allow a user to track equipment from a remote location.

While various embodiments have been described, it will be apparent to those of ordinary skill in the art that many more embodiments and implementations are possible that are within the scope of the claims. The various dimensions described above are merely exemplary and may be changed as necessary. Accordingly, it will be apparent to those of ordinary skill in the art that many more embodiments and implementations are possible that are within the scope of the claims. Therefore, the embodiments described are only provided to aid in understanding the claims and do not limit the scope of the claims.

We claim:

1. A system for identifying an electrical cable comprising:
an electronic tag configured to communicate wirelessly with a portable electronic device, wherein the portable electronic device provides a user interface to allow a user to enter information into the portable electronic device, wherein the user entered information is stored, and
a sleeve attached to an electrical cable configured to transmit electrical power, wherein the sleeve houses the electronic tag.

2. The system for identifying an electrical cable of claim 1, wherein the electronic tag comprises a near field communication type tag.

3. The system for identifying an electrical cable of claim 1, wherein the electronic tag comprises a radio frequency identification type tag.

4. The system for identifying an electrical cable of claim 1, wherein the electrical cable is an extension cord comprising a plug at one end, a receptacle at an opposite end, and a cable portion extending between the plug and the receptacle, and wherein the sleeve is wrapped around the cable portion of the extension cord.

5. The system for identifying an electrical cable of claim 4, wherein the sleeve comprises a top cover and a bottom plate that when secured together wrap around the electrical cable.

6. The system for identifying an electrical cable of claim 5, wherein the top cover and the bottom plate are secured with a snap fit connection.

7. The system for identifying an electrical cable of claim 5, wherein the electronic tag is secured within the sleeve between the bottom plate and the cable portion.

8. The system for identifying an electrical cable of claim 4, wherein the sleeve further comprises a groove that engages a rib on the receptacle.

9. The system for identifying an electrical cable of claim 1, wherein the portable electronic device comprises a processor and a non-transitory computer readable medium storing computer readable instructions that, when executed by the processor causes the processor to at least:
read data stored on the electronic tag when the portable electronic device is placed near the electronic tag;
determine if the electrical cable is registered; and
upon determining that the electrical cable has not been registered, prompt a user using a display of the portable electronic device to enter information.

10. A system for identifying an extension cord comprising:
an electronic tag configured to communicate wirelessly with a portable electronic device, wherein the portable electronic device provides a user interface to allow a user to enter information into the portable electronic device, wherein the user entered information is stored,
an extension cord comprising a plug portion at a first end, a receptacle portion at a second end, and a cable portion extending between the plug portion and the receptacle portion, wherein the extension cord is configured to transmit power from a power source to a powered device, and
a sleeve securing the electronic tag to the extension cord, wherein the sleeve wraps around the extension cord.

11. The system for identifying an extension cord of claim 10, wherein the electronic tag comprises a near field communication type tag.

12. The system for identifying an extension cord of claim 10, wherein the sleeve comprises a top cover and a bottom plate that are secured together with a snap fit connection.

13. The system for identifying an extension cord of claim 10, wherein the sleeve is adjacent to an end of the receptacle portion.

14. The system for identifying an extension cord of claim 10, wherein the sleeve is adjacent to an end of the plug portion.

15. The system for identifying an extension cord of claim 10, wherein the sleeve has a maximum width that is equal to or less than a maximum width of the receptacle portion.

16. The system for identifying an extension cord of claim 10, wherein the portable electronic device comprises a processor and a non-transitory computer readable medium storing computer readable instructions that, when executed by the processor causes the processor to at least:
read data stored on the electronic tag when the portable electronic device is placed near the electronic tag;
determine if the extension cord is registered; and
upon determining that the extension cord has not been registered, prompt a user using a display of the portable electronic device to enter information.

17. The system for identifying an extension cord of claim 10, wherein the portable electronic device comprises a processor and a non-transitory computer readable medium storing computer readable instructions that, when executed by the processor causes the processor to at least:
read data stored on the electronic tag when the portable electronic device is placed near the electronic tag;
determine if the extension cord is registered; and
upon determining that the extension cord has been registered, display information related to the user.

18. The system for identifying an extension cord of claim 10, wherein the electronic tag communicates location information of the electronic tag such that a location of the extension cord may be tracked from a remote location.

19. The system for identifying an extension cord of claim 18, wherein the electronic tag communicates to a global positioning system satellite to determine the location information.

20. A system for identifying an extension cord comprising:
an electronic tag configured to communicate wirelessly with a portable electronic device, wherein the portable electronic device provides a user interface to allow a user to enter information into the portable electronic device, wherein the user entered information is stored,
an extension cord comprising a plug portion at a first end, a receptacle portion at a second end, and a cable portion extending between the plug portion and the receptacle portion, wherein the extension cord is configured to transmit power from a power source to a powered device, and
a label formed from a flexible material securing the electronic tag to the extension cord, wherein the label wraps around the extension cord.
